(19) United States
(12) Patent Application Publication
(10) Pub. No.: US 2009/0202965 A1
(43) Pub. Date: Aug. 13, 2009

(54) Methods and Machine-Readable Media for Interactive Educational Tools

(75) Inventor: Joseph Lee, Killeen, TX (US)

Correspondence Address: MATTHEW E. BURR, 620 CONGRESS AVENUE, STE 320, AUSTIN, TX, 78701, US

(73) Assignee: Educational Victory, L.L.C., Austin, TX (US)

(21) Appl. No.: 12/367,281

(22) Filed: Feb. 6, 2009

Related U.S. Application Data
(60) Provisional application No. 61/063,945, filed on Feb. 7, 2008.

(51) Int. Cl. G09B 19/02

(52) U.S. Cl. 434/191

(57) ABSTRACT

An application teaches a student elementary mathematics. A specific embodiment contains 4 modules: 1. Tutorial and Practice; 2. Homework Helper; 3. Test Simulation; 4.Parental Control. Specific embodiments of the 1st and 2nd Modules have a Help feature. The questions in the tutorial and Practice module are automatically and randomly generated by the software without repetition and according to the chapter the student has selected and other parameters (such as might be set by a parent under the Parental Control module). In specific embodiments, the chapters a student may select from include Addition, Subtraction, Multiplication and Division. A score sheet is generated for each session.

### CROSS REFERENCE TO RELATED APPLICATIONS

This application relates to and claims the benefit of and priority from co-pending U.S. provisional patent application Ser. No. 61/063,945 entitled Methods and Machine-Readable Media for Interactive Educational Tools (Docket No. 20093.1), filed Feb. 7, 2008, the disclosure of which is incorporated herein by reference as if set forth in full.

### TECHNICAL FIELD

This disclosure relates generally to machine-readable media and methods for educational software and more particularly to methods and media for arithmetic instruction by personal computer.

### BACKGROUND

American children now attend school in a high pressure environment of high stakes standardized testing. Computers have become almost ubiquitous in schools and homes. To prepare young students for testing in mathematics and arithmetic in particular, therefore, educational computer software for use either in the home or school to teach arithmetic would be advantageous.

Although educational software has been around for years, there is always a need for a new approach. Individual students have their own learning styles and for any given student it might be the case that the existing educational software is not effective for that student. A new approach is always welcome for those students for whom other products have failed.

### SUMMARY

The present disclosure describes interactive computer application or software which teaches a student elementary mathematics. As used herein, the terms “software”, “application” and “tool” may be used interchangeably as will be evident from the context. A specific embodiment of the software contains 4 modules, namely:

1. Tutorial and Practice

2. Homework Helper

3. Test Simulation

4. Parental Control

Specific embodiments of the 1st and 2nd Modules have a Help feature.

The questions in the tutorial and Practice module are automatically and randomly generated by the software without repetition and according to the chapter the student has selected and other parameters (such as might be set by a parent under the Parental Control module). In specific embodiments, the chapters a student may select from include Addition, Subtraction, Multiplication and Division. Also in specific embodiments, only one chapter may be selected at a time. A score sheet is generated for each session.

Depending on the answer, an interactive message is displayed by the application in specific embodiments. Correct answers are grayed out, for example, to indicate that the answer is locked. A smiley face, for example, or other suitable indicia, is also displayed next to the answer in specific embodiments to indicate a correct answer. A frown face displayed next to an incorrect answer in specific embodiments.

After the score sheet is displayed, the student may choose whether to continue with the session or to exit. The student logs out of the application upon exiting the session.

The homework helper module allows the student to enter one or more elementary math problems assigned by a teacher, for example, in any one of the chapters listed above. The application provides up to five spaces, for example, to enter homework problems and corresponding answers. An optionally selectable Help function is provided alongside each question. A score sheet is generated at the end of each session as described above.

The Test simulation module allows the student to test his or her knowledge of the chapter material. The student may select one or more chapters. The student also selects the number of digits for the problems to be automatically generated by the application for the current test.

The test simulation is time bound. The time for completion of the test is set in the parental control modules by a parent, teacher or other appropriate person but within the overall time for the test there is no limit on how much time the student may take on any one problem. All the questions from all of the selected chapters are automatically generated by the application. A score sheet is generated after expiration of the time. The student can check his answers after the score sheet is generated. No Help function is available in the test simulation module.

Parental control provides a module wherein a parent, teacher or other appropriate person set certain parameters of the application. For example, a parent can set the level of help available in the modules that provide help and the time for test completion in the test Simulation module.

Specific embodiments of the application include piracy protection in the form of key encryption that generates a unique registration number that is required to be entered before the application can be installed on a user's computer. Additionally, a user profile may be created by the owner at the time of installation.

Specific embodiments of the application use both visual and audio cues to indicate when a question has been answered correctly or incorrectly.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of an interactive home page for an exemplary embodiment of an educational application of the present disclosure.

FIG. 2 is a schematic flow chart of an exemplary embodiment of a tutorial and practice module for an educational tool of the present disclosure.

FIG. 3 is a diagrammatic illustration of an exemplary specific embodiment of a user interface for a tutorial and practice module for an educational tool of the present disclosure.

FIG. 4 is a diagrammatic illustration of an exemplary specific embodiment of a tutorial and practice module of FIG. 3 with a Help Function.

FIG. 5 is a schematic flow chart of an exemplary embodiment of a homework helper module for an educational tool of the present disclosure.

FIG. 6 is a diagrammatic illustration of an exemplary specific embodiment of a user interface for a homework helper module of FIG. 5.

FIG. 7 is a diagrammatic illustration of an exemplary specific embodiment of a score sheet for a homework helper module of FIG. 5.

FIG. 8 is a schematic flow chart of an exemplary embodiment of the help function for an educational tool of the present disclosure.

FIG. 9 is a schematic flow chart of an exemplary embodiment of a test simulation module for an educational tool of the present disclosure.

FIG. 10 is a diagrammatic illustration of an exemplary specific embodiment of a test simulation set up interface for a test simulation module for an educational tool of the present disclosure.

FIG. 11 is a diagrammatic illustration of an exemplary specific embodiment of a test simulation module for addition of FIG. 10.

FIG. 12 is a schematic flow chart of an exemplary embodiment of a parental control module for an educational tool of the present disclosure.

### DETAILED DESCRIPTION

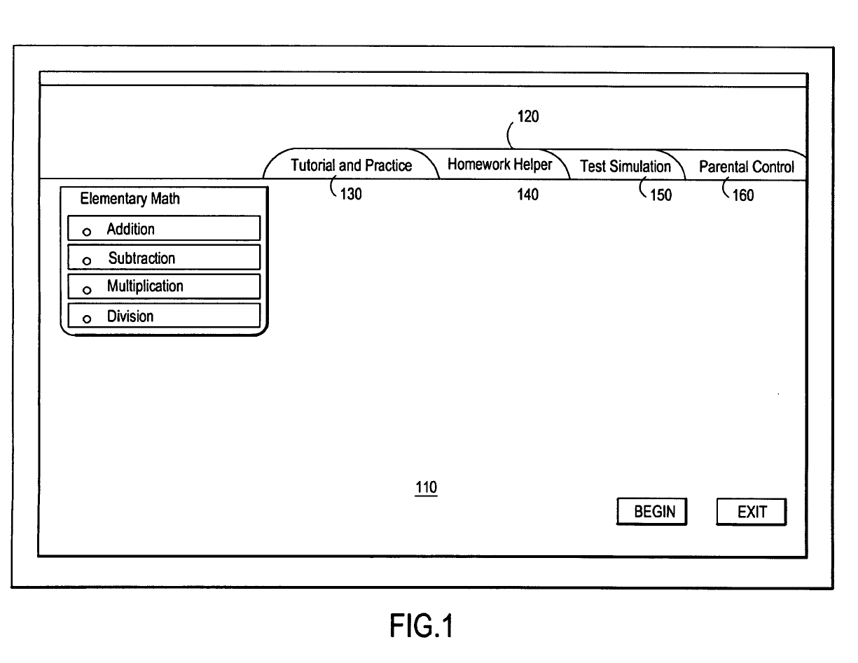

Referring to FIG. 1 of the drawings, FIG. 1 is a diagrammatic illustration of an interactive home page for an exemplary embodiment of an educational application of the present disclosure. Interactive instructional software of the present disclosure offers a specific embodiment for students to learn, practice, and test elementary mathematics. The specific embodiment primarily contains 4 modules, namely:

1. Tutorial and Practice

2. Homework Helper

3. Test Simulation

4. Parental Control

The 1st and 2nd Modules have a Help feature which is described herein below.

A student, for example, launches an application on a computer for instruction for learning arithmetic and opens application home page 110. Home page 110 provides main menu 120 which displays four modules. The student optionally selects any one of the four modules: Tutorial and Practice 130, Homework Helper, 140, test simulation, 150 or Parental Control 160.

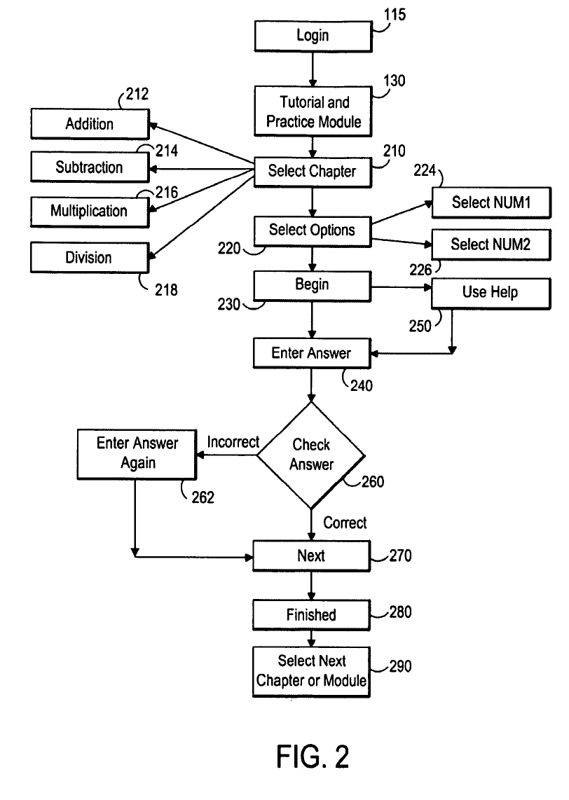

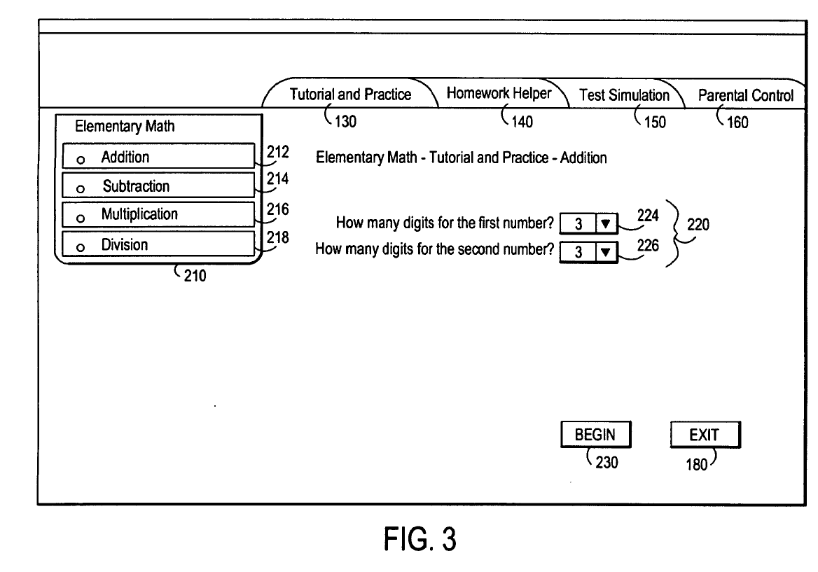

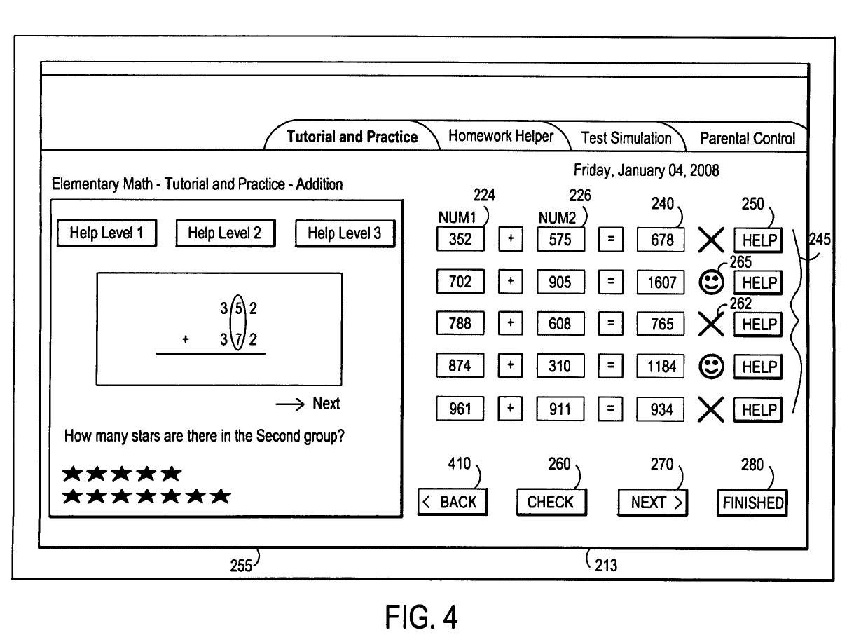

Referring now to FIGS. 2, 3, and 4, FIG. 2 is schematic flow chart of an exemplary embodiment of a tutorial and practice module for an educational tool of the present disclosure; FIG. 3 is a diagrammatic illustration of an exemplary specific embodiment of a user interface for a tutorial and practice module for an educational tool of the present disclosure and FIG. 4 is a diagrammatic illustration of an exemplary specific embodiment of a tutorial and practice module of FIG. 3 with a Help Function. The following description refers to FIGS. 2, 3 and 4.

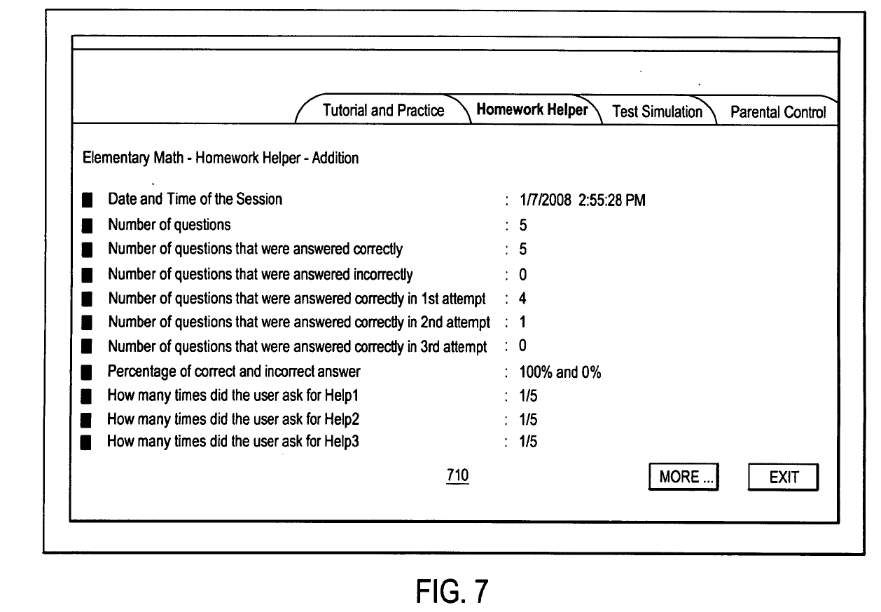

In the specific embodiment of the tutorial and practice module 130, one or more students login and practice their basic arithmetic (also referred to herein as elementary math). The questions in tutorial and practice are randomly generated by the software system of the present disclosure according to the selection of a chapter 210 a student has made. Unique questions are generated without being repeated. The student selects the chapters 210 he would like to practice, such as Addition 212, Subtraction 214, Multiplication 216 and Division 218. Only one chapter can be selected at a time. Help 250 is provided alongside for each question and a score sheet (not shown for tutorial and practice but see FIG. 7 for an example of a score sheet for the homework helper) is generated at the end of the session. All questions are evaluated equally.

Selecting Chapters in Tutorial and Practice:

After selecting a chapter 210 in Tutorial and Practice the student clicks on <BEGIN> 230 button to start his session.

Options 220: To be set by the student prior to beginning of the session. Student has to choose his options 220 before he begins his practice. Elementary math is for two operands, referred as Num1 224 and Num2 226. He has to select number of digits for Num1 and Num2.

Addition: Number of Digits 224 in 1st number=1-5. Number of digits 226 in 2nd number=1-5.

Subtraction: Number of Digits in 1st number=1-5. Number of digits in 2nd number=1-5. In Subtraction: Num1>Num2.

Multiplication: Number of Digits in 1st number=1-3. Number of digits in 2nd number=1-2.

Division: Number of Digits in 1st number=1-3. Number of digits in 2nd number=1-2.

After entering the digits 224,226, the student clicks the <begin> button 230 to prompt application 110 to generate questions 245 shown on the right side of FIG. 4. <Exit> button 180 returns application 110 to home page 120.

Answering questions 240:

5 Questions 245 are displayed per page. Application software generates all questions randomly.

Student can enter the answers 240 in the box provided next to the question. Specific embodiments do not support division by zero and will display Error message in such case. Division will accept answers up to 4 decimal points in specific embodiments.

Addition and Multiplication can have Num2>or=Num1 or vice versa. A text box will not allow the student to enter more numbers than stipulated.

The student can solve any problem on the worksheet randomly. The student can make any number of attempts to solve a problem.

Special characters:

Answers to the questions are only numeric. If any special characters or letters are entered then the box is turned red. Help 250 cannot be accessed until the text box has turned returned to normal, which happens only after removing the letter from the box. The student has to rectify the error before he moves ahead.

Help 250:

The student can request for help for a particular question by clicking on the <HELP> 250 button next to a particular question. This action opens Help panel 255 (FIG. 4) to the left side of the addition question panel 213. Help is provided on the left hand side of the window because, it is believed, psychologically westerners place greater importance on information on the left side of a page because westerners read left to right. Help provides the actual teaching function of the educational tool described herein and putting the Help workspace on the left side of the window emphasizes its educational significance.

Three levels of help are defined in the specific embodiment described herein:

Help 1: Explains the problem

Help 2: Shows step by step the process of solving the question

Help 3: Gives the answer to the particular problem

The help levels are set by the parent in <PARENTAL CONTROL> tab on the main menu. The student can request help 250 anytime. Either before making any attempt to answer the problem on his own or after making several attempts. Help 250 can be accessed only in an orderly fashion. Student has to first use Help1 before proceeding to Help 2 and Help 1 and 2 before moving on to Help 3.

Check button 260:

A <CHECK> button 260 is provided for every page. The student has to verify/check his answers before he moves on to the next page. The student can check for correctness after he finished answering one question or after he is done answering all his questions on the page. The student cannot move forward without checking his answers for correctness.

An automatic message would be displayed reminding the student to check his answers for correctness. A correct answer 265 will have a small green smile icon next to it and wrong answer 262 a red icon to indicate whether the answer is correct or not. If the student has answered his question correctly then the answer would be grayed out.

Next Button 270:

The student can click on the <NEXT> button 270 to move to the next page to answer his questions. The student can move to the next page even without answering any questions on the current page. Another set of text boxes would be displayed for the student to answer his questions and answers.

Back button 410:

An option is given to the student to go back to the previous page and answer any questions he has not answered. Again the student can go back without answering any questions on the current page if he wished to. When the student uses back button 410 to come to the previous page the correct answers on that page are grayed out or “Locked”. The student cannot make any changes to that answer.

Finished:

Student will click on <FINISHED> button 280 to end his current session.

Messages in Tutorial and Practice:

Student is prompted to select the chapter before proceeding with the <BEGIN> button 230.

Student can enter only numeric values for answers 240. If the student enters anything other than numeric values, the text box will be highlighted RED and a message would appear at the bottom of the screen as follows “Please enter only Numeric values.”

An Alert message will be displayed when the student tries to use help other than in orderly fashion.

Specific embodiments of the application provide one or more visual and or audio performance indicator. For example, a visual message is displayed after the student checks his answer for correctness. For example: “Good Job” when the answer is correct.

“Oops! try again” when the answer is wrong.

In addition, an audio cue is played that speaks the above phrases. The message disappears as soon as the student moves over to the next question.

If the student tries to check his answers without actually answering them, the system generates a message asking the student to first answer the question.

Use Case Scenarios:

The student navigates from one Module to another and one chapter to another at any time. An Alert message is displayed reconfirming the navigation.

If the student checked his answer only for one question and ignored for all of the others on the page then first the message saying good job for the answered question appears first and then reminds the student to check all the questions.

When a student enters a letter or special character instead of the number in the answer field the box is turned red. As soon as the letter is removed the box turns normal.

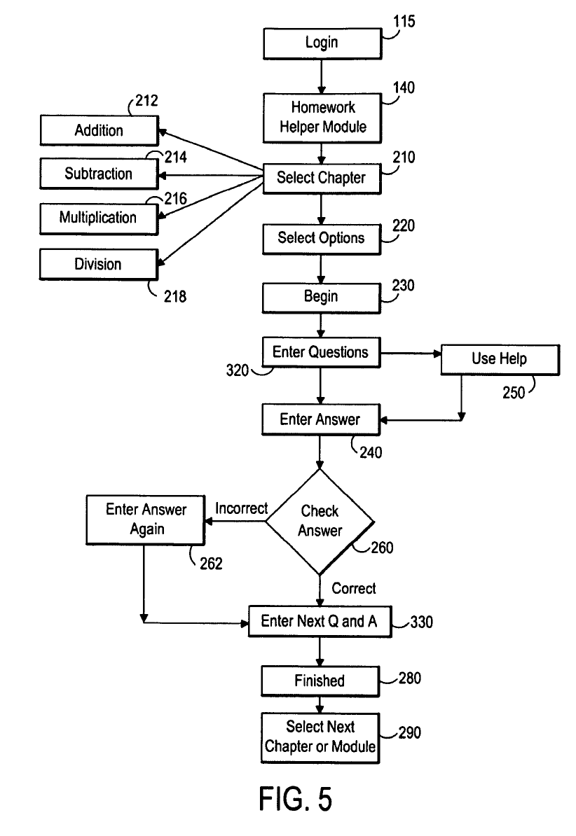

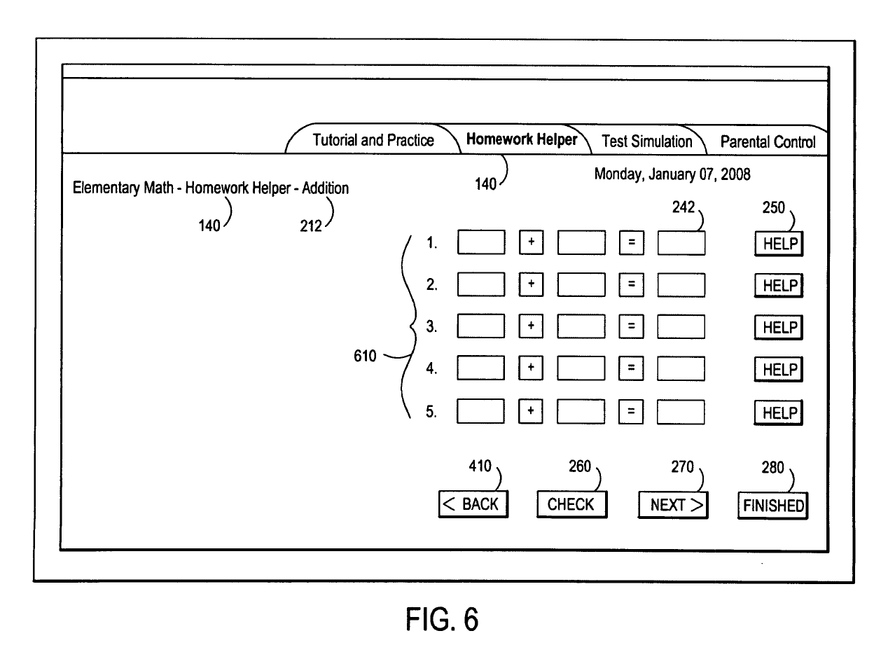

Referring now to FIGS. 5, 6 and 7, FIG. 5 is a schematic flow chart of an exemplary embodiment of a homework helper module for an educational tool of the present disclosure; FIG. 6 is a diagrammatic illustration of an exemplary specific embodiment of a graphical user software interface for a homework helper module of FIG. 5 and FIG. 7 is a diagrammatic illustration of an exemplary specific embodiment of a score sheet for a homework helper module of FIG. 5. The following description refers to FIGS. 5, 6, and 7.

In the Homework Helper module 140 the student is enters, or is prompted by the application to enter, the math questions assigned by a teacher, for example. The student then makes a selection 210 of the chapter he wishes to work on such as Addition 212, Subtraction 214, Multiplication 216 and Division 218. Only one chapter can be selected at a time. The student enters 320 his home work questions one by one in the layout 610 provided.

There are 5 “boxes' provided to enter the questions. User can enter his answer 240 in the space 242 provided next to the problem. Help 250 is provided alongside for each question and a score sheet 710 is generated at the end of the session. All questions are evaluated equally.

Selecting Chapters in Homework Helper:

After selecting 210 a chapter in homework helper the student clicks on <BEGIN> button 230 (See FIG. 3) to start his session.

Entering Questions and answers:

5 Text boxes appear per page 610. The student enters his questions 230 either randomly or in proper order according to his choice. A text box 242 is provided next to the questions for the answers.

The student enters the answer. The text box 242 will not allow the student to enter more numbers than stipulated: Addition and Subtraction have Num1: 1-5 and Num2: 1-5. Multiplication: 3×2. Division: 3×2. Division by Zero is not possible; Error message will be displayed. Division will accept answers up to 4 decimal points. In Subtraction: Num1>or=Num2. Addition and Multiplication can have Num2>or=Num1 or vice versa.

Special characters:

Answers to the questions have to be only numeric. If any special characters or letters are entered then the box is turned red. Help cannot be accessed until the text box has turned returned to normal, which happens only after removing the letter from the box. No activity can be done until the special character is removed.

Help: The student can request for help for a particular question by clicking on the <HELP> button 250 next to a particular question. Three levels of help are provided:

Help 1: Explains the problem.

Help 2: Shows step by step the process of solving the question.

Help 3: Gives the answer to the particular problem.

The help levels are set by the parent in <PARENTAL CONTROL> tab 160 on the main menu.

Student can request for help anytime. Either before making any attempt to answer the problem on his own or after making several attempts. Help can be accessed only in an orderly fashion. Student has to first use Help1 before proceeding to Help 2 and Help 1 and 2 before moving on to Help 3.

Check button:

A <CHECK> button 260 is provided for every page. The student has to verify/check his answers before he moves on to the next page. The student can check for correctness after he has finished answering one question or after he is done answering all his questions on the page. Student cannot move forward without checking his answers for correctness. An automatic message is displayed reminding the student to check his answers for correctness. Correct answer will have a small green smile icon next to it and wrong answer a red icon to indicate whether the answer is correct or not.

Next Button:

The student can click on the <NEXT> button 270 to move to the next page to answer his questions. The student can move to the next page even without answering any questions on this page. Another set of text boxes 242 is displayed for the student to answer his questions and answers.

Back button 410:

An option is given to the student to go back to the previous page and answer any questions he has not answered. Again the student can go back without answering any questions on the current page if he wished to. When the student uses back button 410 to come to the previous page the correct answers on that page are grayed out or “Locked”. The student cannot make any changes to that answer.

Finished: Student will click on <FINISHED> button 280 to end his current session. After finishing the student may select 290 the next chapter or module.

Messages in Home Work helper:

Student is prompted to select the chapter before proceeding with the <BEGIN> button 230. The student can enter only numeric values for answers. If the student enters anything other than numeric values, the text box will be highlighted RED and a message would appear at the bottom of the screen as follows “Please enter only Numeric values”

An Alert message will be displayed when the student tries to use help other than in orderly fashion.

An interactive message will be displayed after the student checks his answer for correctness:

“Good Job” when the answer is correct.

“Oops! try again” when the answer is wrong.

An alert message will appear when the student clicks on the Help button 250 next to the blank question, asking him to first enter the question.

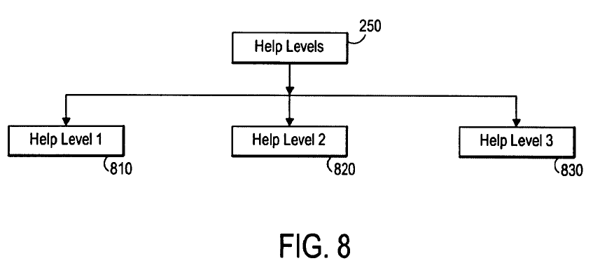

FIG. 8 is a schematic flow chart of an exemplary embodiment of the help function for an educational tool of the present disclosure. Three levels of help 250 are provided:

Help 1 810: Explains the problem without giving the answer. The problem is broken down into steps or smaller parts. For example, in addition, help1 prompts the student to group the numbers. See FIG. 4 at 255. Help 1 does not provide illustrations.

Help 2 820: Shows step by step the process of solving the question without giving the answer. This level gives an illustration or example of how the problem can be solved.

Help 3 830: Gives the answer to the particular problem.

The help levels are set by the parent in <PARENTAL CONTROL> tab on the main menu.

Help is generated dynamically pertaining to the problem in question. Help is displayed on the left hand side of the application window (the problem is on the right hand side). Help in the elementary math chapters includes help with and without carryovers and the carryovers are color coded. In the Division chapter, Help addresses small and long division and with and without remainders.

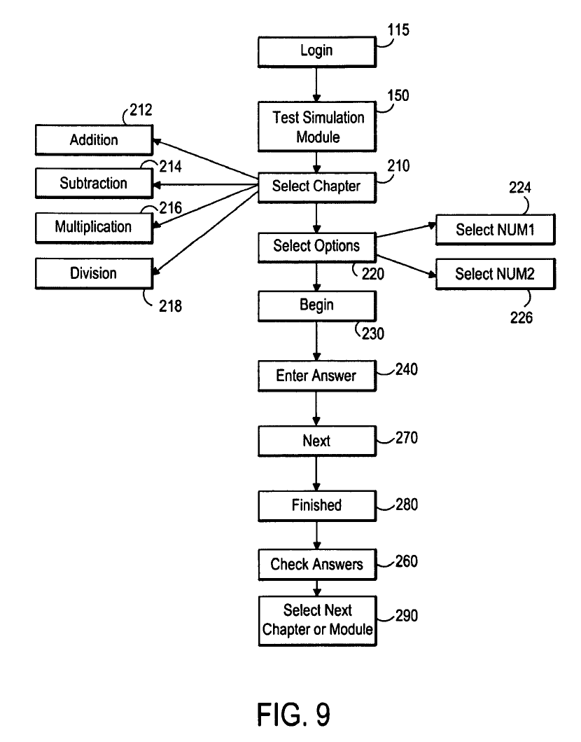

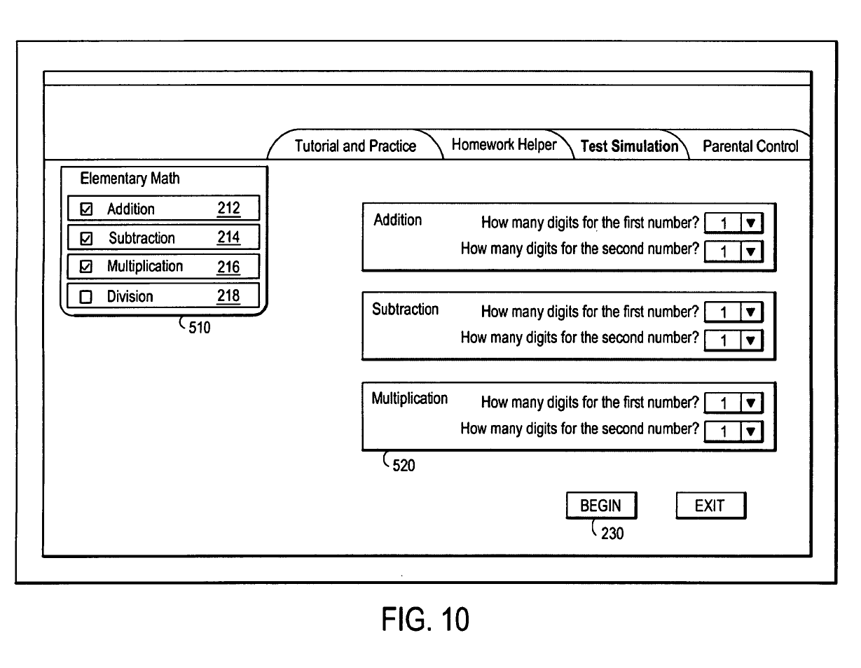

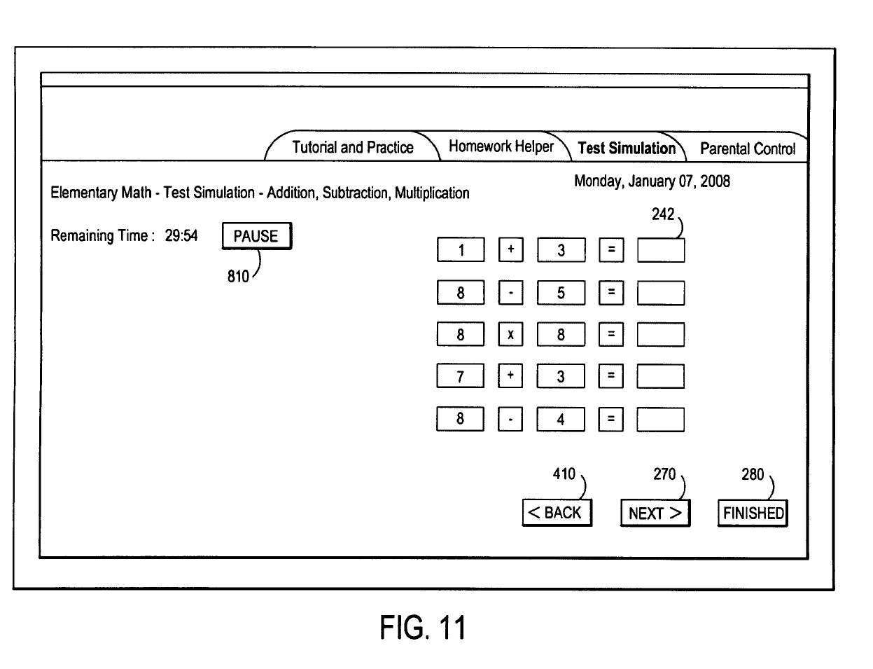

Referring now to FIGS. 9, 10, and 11, FIG. 9 is schematic flow chart of an exemplary embodiment of a test simulation module for an educational tool of the present disclosure; FIG. 10 is a diagrammatic illustration of an exemplary specific embodiment of a test simulation set up interface for a test simulation module for an educational tool of the present disclosure and FIG. 11 is a diagrammatic illustration of an exemplary specific embodiment of a test simulation module for addition of FIG. 10. The following description refers to FIGS. 9, 10 and 11.

In a specific exemplary embodiment of the Test Simulation module 150, the student can test his knowledge in various chapters 212-218 in elementary math. When the student clicks on Test Simulation tab 150 on the main menu, a list 510 of chapters 510 appears. Student can select 210 one or more chapters 212-218 at a given time and enter his options 520 about the number of digits for the current test. Test simulation does not offer any help 250. The Test Simulation is time bound. Time is preset by the parent in parental control tab. All the questions are system generated. An equal number of questions appear from all the chapters the student has chosen. Student can check his answers 260 after the score sheet is displayed.

Selecting Chapters in Test Simulation:

A student can select 210 any numbers of chapters 212-218 from chapter list 510 which has check boxes that the student can mark to select the chapters he wants to test on. He can choose any number of chapters at the same time. The same number of questions appears from all the chapters selected. The student clicks <begin> button 230 to begin the test.

Answering questions:

5 Text boxes 242 with questions appear per page. The software generates all questions randomly. A text box 242 is provided next to the questions for the student to enter his answers.

Elementary math does not support Division by Zero and Error message will be displayed. Addition and Multiplication can have Num2>Num1 or vice versa. The text box will not allow the student to enter numbers more than stipulated. Division will accept answers up to 4 decimal points.

The student can solve any problem on the worksheet randomly. He is responsible for the amount of time he wishes to spend on one particular problem. There is no time limit on individual questions but there is an overall time limit for completing the test.

Options:

Student has to choose his options 520 before he begins his practice test. Elementary math is for two operands, referred as Num1 and Num2. The student has to select number of digits for Num1 and Num2.

Addition 212: Number of Digits in 1st number=1-5. Number of digits in 2nd number=1-5.

Subtraction 214: Number of Digits in 1st number=1-5. Number of digits in 2nd number=1-5. Num1>or=Num2.

Multiplication 216: Number of Digits in 1st number=1-3. Number of digits in 2nd number=1-2.

Division 218: Number of Digits in 1st number=1-3. Number of digits in 2nd number=1-2.

Help:

No Help is provided in Test Simulation.

Next Button:

The student can click on the <NEXT> button 270 to move to the next page to answer his questions. The student can move to the next page even without answering any questions on current page displayed on screen. Another set of questions would be displayed for the student to solve.

Back button 410:

An option is given to the student to go back to the previous page and answer any questions he has not answered previously. Again the student can go back without answering any questions on the current page if he wished to.

Student even has an option not to answer any question given in the test and finish the test.

Finished:

Student will click on <FINISHED> button 280 to end his current session.

Check:

Student can check his answers at the end of the test, by clicking on the CHECK button 260.

Pause and Start:

Student can pause his test for a period of 5 min any number of times during the test with <pause> button 810 which then toggles to display <start>. When the test is paused all the questions would be grayed, student cannot enter his answers during this time. The Next 270 and Back buttons are functional even though the questions are grayed out. When the 5 min for pause is over the session automatically starts from the same clock time as before the pause. The student can start his session again by pressing on the <start> button 810.

Finish button 280 is also grayed out. A student cannot finish the session or test in pause mode. He has to be in Test mode with the clock countdown working.

When in pause the <FINISH> button 280 is disabled.

Session Timing:

Parent can set the time of the test in the Parental Control tab. The countdown starts as soon as the student clicks on the <BEGIN> button 230.

Messages in Test Simulation:

Student is prompted to select the chapter before proceeding with the <BEGIN> button 230. Student can enter only numeric values for answers. If the student enters anything other than numeric values, the text box will be highlighted RED and a message would appear at the bottom of the screen as follows “Please enter only Numeric values”.

After the student has taken the test and the time is over, then a message appears saying “Time's up . . . pencils down” and then score sheet is automatically produced.

Use Cases: Scenarios

Student enters an alphabet or a special character in the answer box, the system highlights the box in Red and displays a message “Please enter only Numeric values”. In situations like this the system should allow the student to move to the next page and proceed with the test and when the student clicks on back button, this particular field should be blank, unlighted, the alphabet entered previously should disappear.

Student cannot click on finish when in paused mode.

The system will consider any questions answered after the time is up as wrong and the score sheet will reflect the same. This is for the case where the student has tried to enter his answer with only less than one sec.

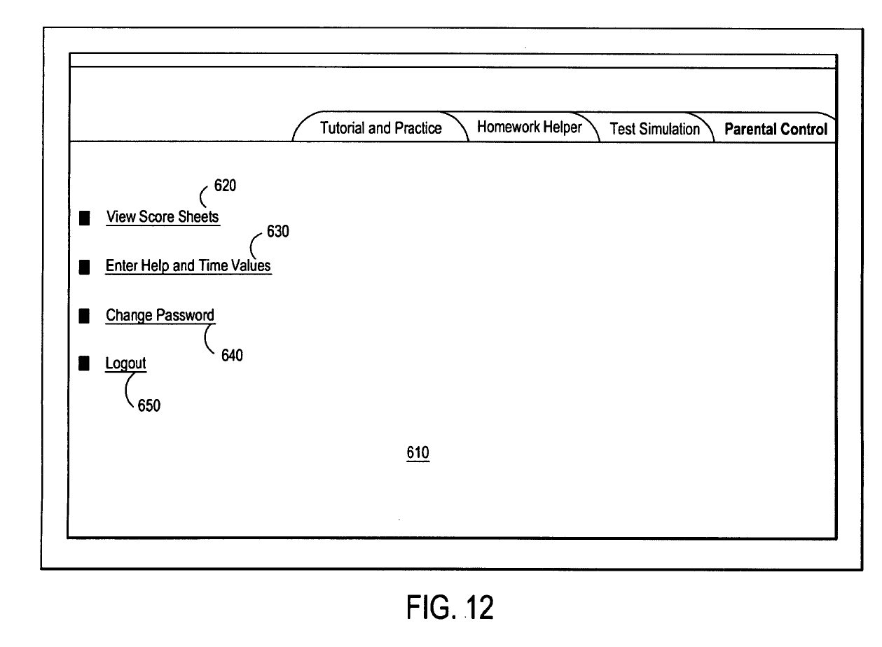

FIG. 12 is a schematic flow chart of an exemplary embodiment of a parental control module 160 for an educational tool of the present disclosure. Activation of tab 160 brings up a login panel (not shown) for the parent to enter a password. Successful login brings up the Parental Control Window 610. Parameters that a parent can set are: View Score Sheet 620

Enter Help and Time Values 630

Change Password 640

Parental Control Password: Parental Control is password protected. Maximum length is 6 alphanumeric characters.

Change Password 640:

A provision is provided to change the parent's password. In case the parent forgets his password, he or she would have to contact customer service.

Enter Help and Time values 630:

Time is set only for Test Simulation module 150. Parent sets the duration of the test that a student will take prior to the session. Specific embodiments provide that test timing can be set in increments of 10 min, up to 100 min (1 hr 40 min).

Help 250 levels can be set only for Tutorial and practice and Homework helper modules. Test simulation does not have Help 250. Parent can chose from Help1 410 to Help3 430.

View Score Sheet:

On the Left hand side of the page all the modules and chapters are listed as collapsible tree and nodes. The parent clicks on the chapter to view the session. Since only one chapter can be selected at a time for taking a test, score sheets are also provided in the same manner.

Although the educational tool of the present disclosure has been described herein primarily with respect to elementary arithmetic as a specific embodiment, it will be understood by those skilled in the art that the disclosure is easily adapted to more advanced mathematical subjects, including but not limited to fractions and percentages, geometry, pre-algebra, algebra and trigonometry.

In addition to the foregoing embodiments, the present disclosure describes instructions or programs stored on machine readable medium to operate computers and devices according to the principles of the present disclosure. Machine readable media include, but are not limited to, magnetic storage medium (e.g., hard disk drives, floppy disks, tape, etc.), optical storage (CD-ROMs, optical disks, etc.), and volatile and non-volatile memory devices (e.g., EEPROMs, ROMs, PROMs, RAMs, DRAMs, SRAMs, firmware, programmable logic, etc.). Furthermore, machine readable media include transmission media (network transmission line, wireless transmission media, signals propagating through space, radio waves, infrared signals, etc.) and server memories. Moreover, machine readable media includes many other types of memory too numerous for practical listing herein, existing and future types of media incorporating similar functionally as incorporate in the foregoing exemplary types of machine readable media, and any combinations thereof. The programs and applications stored on the machine readable media in turn include one or more machine executable instructions which are read by the various devices and executed. Each of these instructions causes the executing device to perform the functions coded or otherwise documented in it. Of course, the programs can take many different forms such as applications, operating systems, Perl scripts, JAVA applets, C programs, compilable (or compiled) programs, interpretable (or interpreted) programs, natural language programs, assembly language programs, higher order programs, embedded programs, and many other existing and future forms which provide similar functionality as the foregoing examples, and any combinations thereof.

Accordingly, the present disclosure describes machine-readable media containing instructions for execution by a machine such as a computer whereby the instructions cause the machine to provide an education application for teaching arithmetic to a student by presenting one or more arithmetic problem to be solved by the student. The application includes but is not necessarily limited to a home page that provides a workspace for problem solving, the workspace further comprising a right side for problem solving and a left side for help. The application further provides a help function; a tutorial and practice module; a homework helper module; a test simulation module; and parental controls. The homework helper module allows a student to enter one or more homework problem and wherein the application in the tutorial and practice module and the test simulation module automatically generates arithmetic problems according to parameters set by the student and a parent.

Additionally, the present disclosure describes one or more method for teaching arithmetic to a student. For example, such a method has the steps of launching an application described above on a machine from a machine readable medium containing the application in machine-readable form, at least attempting at least one problem from either of the tutorial and practice module, the homework helper module, or the test simulation module; and closing the application.

Anti-piracy technology for specific embodiments of software of the present disclosure includes key generation which associates a unique key to each copy of the software. The unique key serves as a registration number for that copy of the software. Installation of the software in such specific embodiments requires that the owner enter the registration number that corresponds to the owner's copy of the software.

Additionally, a user profile may be created by the owner at the time of installation. Specific embodiments of the application use both visual and audio cues to indicate when a question has been answered correctly or incorrectly.

Many modifications and other embodiments of the educational tool described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A machine-readable medium containing instructions for execution by a machine whereby the machine provides an education application for teaching arithmetic to a student by presenting one or more arithmetic problem to be solved by the student, the application comprising:
a home page that provides a workspace for problem solving, the workspace further comprising a right side for problem solving and a left side for help;
a help function;
a tutorial and practice module;
a homework helper module;
a test simulation module; and
parental controls,
wherein the homework helper module allows a student to enter one or more homework problem and wherein the application in the tutorial and practice module and the test simulation module automatically generates arithmetic problems according to parameters set by the student and a parent.

2. The application of claim 1 wherein homework helper prompts the student to enter one or more homework problem.

3. The application of claim 1, wherein help explains how to solve the problem.

4. The application of claim 3, wherein help explains how to solve the problem step by step.

5. The application of claim 4 wherein help solves the problem.

6. The application of claim 1, wherein the homework helper module provides one or boxes to enter one or more homework problem and further wherein the homework helper module selectively checks the answer to one or more homework problem.

7. The application of claim 1, further comprising one or more arithmetic chapters in the tutorial and practice module and the test simulation module.

8. The application of claim 7, wherein at least one of the chapters is addition.

9. The application of claim 7 wherein at least one of the chapters is subtraction.

10. The application of claim 7 wherein at least of the chapters is multiplication.

11. The application of claim 7 wherein at least one of the chapters is division.

12. The application of claim of claim 7, wherein the test simulation module provides a simulation test of one or more chapters and further wherein the test simulation is timed.

13. The application of claim 1, wherein help is not available while the student is using the test simulation module.

14. The application of claim 13, wherein the test simulation comprises a pause feature that permits the student to pause the timing of the test simulation for a defined period of time.

15. The application of claim 1, further comprising one or more visual and audio performance indicator.

16. A method for teaching arithmetic to a student, the method comprising the steps of:
a. Launching an application on a machine from a machine readable medium containing the application in machine-readable form, wherein the application comprises:
a home page that provides a workspace for problem solving, the workspace further comprising a right side for problem solving and a left side for help;
a help function;
a tutorial and practice module;
a homework helper module;
a test simulation module; and
parental controls,
wherein the homework helper module allows a student to enter one or more homework problem and wherein the application in the tutorial and practice module and the test simulation module automatically generates arithmetic problems according to parameters set by the student and a parent;
b. at least attempting at least one problem from either of the tutorial and practice module, the homework helper module, or the test simulation module; and
c. closing the application.

17. The method of claim 16, further comprising providing one or more visual and audio performance indicator.

18. The method of claim 16, wherein the application further comprises one or more arithmetic chapters in the tutorial and practice module and the test simulation module.
